(19) United States
(12) Patent Application Publication
(10) Pub. No.: US 2025/0349086 A1
(43) Pub. Date: Nov. 13, 2025

(54) PROVIDING REAL-TIME VIRTUAL BACKGROUND IN A VIDEO SESSION

(71) Applicant: Microsoft Technology Licensing, LLC, Redmond, WA (US)

(72) Inventors: Qi ZHU, Suzhou (CN); Jia-Hua LEE, Suzhou (CN); Haoyu LI, Suzhou (CN); Qiongfang ZHANG, Suzhou (CN)

(21) Appl. No.: 18/859,507

(22) PCT Filed: Apr. 13, 2023
(86) PCT No.: PCT/US2023/018439

§ 371 Date: Oct. 23, 2024

(30) Foreign Application Priority Data
Jun. 1, 2022 (CN) 202210619268.8

(51) Int. Cl. G06T 19/00; G06T 15/50

(52) U.S. Cl. CPC G06T 19/006; G06T 15/50; G06T 2219/024

(57) ABSTRACT

The present disclosure proposes methods, apparatuses, computer program products and non-transitory computer-readable medium for providing real-time virtual background in a video session. Real-time environment status information of a target user may be obtained, the real-time environment status information at least comprising geographic location information of the target user. A virtual visual representation corresponding to the real-time environment status information may be determined. A real-time virtual background may be formed through adding the virtual visual representation into a predetermined layout template. A mixed image corresponding to the target user may be formed through combining the real-time virtual background and a real-time human image of the target user. The mixed image may be presented in a user display region corresponding to the target user in a user interface of the video session.

### BACKGROUND

Video session service is becoming a part of people's daily lives. A user of a video session service may create or join a video session through the video session service. A video session may refer to a session that at least supports users' participation in an approach of real-time video. Multiple users participating in the same video session may communicate with each other in a virtual session space created by the video session service for the video session. There are various video session services, e.g., video meeting service provided by an online meeting application, video chatting service provided by a social networking software, etc.

### SUMMARY

This Summary is provided to introduce a selection of concepts that are further described below in the Detailed Description. It is not intended to identify key features or essential features of the claimed subject matter, nor is it intended to be used to limit the scope of the claimed subject matter.

Embodiments of the present disclosure propose methods, apparatuses, computer program products and non-transitory computer-readable mediums for providing real-time virtual background in a video session. Real-time environment status information of a target user may be obtained, the real-time environment status information at least comprising geographic location information of the target user. A virtual visual representation corresponding to the real-time environment status information may be determined. A real-time virtual background may be formed through adding the virtual visual representation into a predetermined layout template. A mixed image corresponding to the target user may be formed through combining the real-time virtual background and a real-time human image of the target user. The mixed image may be presented in a user display region corresponding to the target user in a user interface of the video session.

It should be noted that the above one or more aspects include the features hereinafter fully described and particularly pointed out in the claims. The following description and the drawings set forth in detail certain illustrative features of the one or more aspects. These features are only indicative of the various ways in which the principles of various aspects may be employed, and this disclosure is intended to include all such aspects and their equivalents.

### BRIEF DESCRIPTION OF THE DRAWINGS

The disclosed aspects will hereinafter be described in conjunction with the appended drawings that are provided to illustrate and not to limit the disclosed aspects.

FIG. 1 illustrates an existing exemplary user interface of a video session.

FIG. 2 illustrates an exemplary process for providing real-time virtual background in a video session according to an embodiment.

FIG. 3 illustrates exemplary layout templates according to embodiments.

FIG. 4 illustrates an example of forming a mixed image according to an embodiment.

FIG. 5 illustrates an exemplary process for determining a virtual visual representation according to an embodiment.

FIG. 6 illustrates an example of a virtual visual representation according to an embodiment.

FIG. 7 illustrates an exemplary process for determining a virtual visual representation according to an embodiment.

FIG. 8 illustrates an example of a virtual visual representation according to an embodiment.

FIG. 9 illustrates an exemplary process for determining a virtual visual representation according to an embodiment.

FIG. 10 illustrates examples of virtual visual representations according to an embodiment.

FIG. 11 illustrates examples of virtual visual representations according to an embodiment.

FIG. 12A and FIG. 12B illustrate an exemplary user interface of a video session according to an embodiment.

FIG. 13 illustrates a flowchart of an exemplary method for providing real-time virtual background in a video session according to an embodiment.

FIG. 14 illustrates an exemplary apparatus for providing real-time virtual background in a video session according to an embodiment.

FIG. 15 illustrates an exemplary apparatus for providing real-time virtual background in a video session according to an embodiment.

### DETAILED DESCRIPTION

The present disclosure will now be discussed with reference to several example implementations. It is to be understood that these implementations are discussed only for enabling those skilled in the art to better understand and thus implement the embodiments of the present disclosure, rather than suggesting any limitations on the scope of the present disclosure. In a video session created by a video session service, a current user participating in the video session may turn on a camera of a terminal device running the video session service, in order to present a real-time camera view image at this user's side captured by the camera in a user interface of the video session, and enable other users participating in the video session to see the real-time camera view image of the current user. A real-time camera view image may refer to a real-time image actually captured or shot by a camera, which may include a human image of a user, an actual background image of a place where a user is located, etc. In some cases, a video session service may provide an actual background image replacement function to replace an actual background image captured by a camera by a predetermined background image. The predetermined background image may be pre-selected by a user or automatically pre-set. Embodiments of the present disclosure propose to provide real-time virtual background in a video session, and the real-time virtual background may reflect real-time environment status information of a user. Herein, the real-time environment status information may refer to various types of status information associated with the real-world environment where a user is currently located, which may include, e.g., geographic location information, time information, weather information, etc. Accordingly, the real-time virtual background may simulate a real-world scene in order to visually reflect a geographic location (e.g., country, city, etc.) where the user is located, the current time corresponding to the geographic location, the current weather at the geographic location, etc. For example, the geographic location may be visually reflected through representative buildings, natural landscapes, animals, plants, etc. For example, the current time may be visually reflected by light intensity, light angle, etc. For example, the weather may be reflected by the sky, light intensity, weather effects, etc.

Multiple users participating in the same video session may be from different countries or regions, in different time zones, etc., and thus there is a need for mutual understanding of personal real-time environment status information among these users. The actual background image replacement function in the existing video session service only aims to replace an actual background image captured by a camera by a predetermined background image, however, the predetermined background image cannot reflect real-time environment status information of a user.

According to the embodiments of the present disclosure, an actual background image captured by a camera may be replaced by a real-time virtual background, and the real-time virtual background may be used for reflecting real-time environment status information of a user. For example, the embodiments of the present disclosure may determine a virtual visual representation corresponding to real-time environment status information of a target user, form a real-time virtual background with the virtual visual representation and a layout template, form a mixed image corresponding to the target user with the real-time virtual background and a real-time human image of the target user, and present the mixed image in a user interface of a video session. Thus, when other users participating in the video session see the mixed image, these users may intuitively and easily perceive or understand the real-time environment status information associated with the target user, e.g., geographic location, current time, current weather, etc.

The embodiments of the present disclosure may continuously update the real-time virtual background according to the update or change of the real-time environment status information of the target user, so as to reflect the change of the real-time environment status information of the target user through the update of the real-time virtual background. Thus, the real-time virtual background may be continuously changed or updated over time.

The embodiments of the present disclosure may effectively improve the realness and interestingness of a video session service, build a more immersive virtual session space, enhance personalized experiences of users, promote mutual perception and intimacy among users, etc. It should be understood that although multiple parts of the following discussion take a video meeting service as an example, the embodiments of the present disclosure are not limited to be applied in a video meeting service, but may also be applied in any other types of video session service in a similar approach.

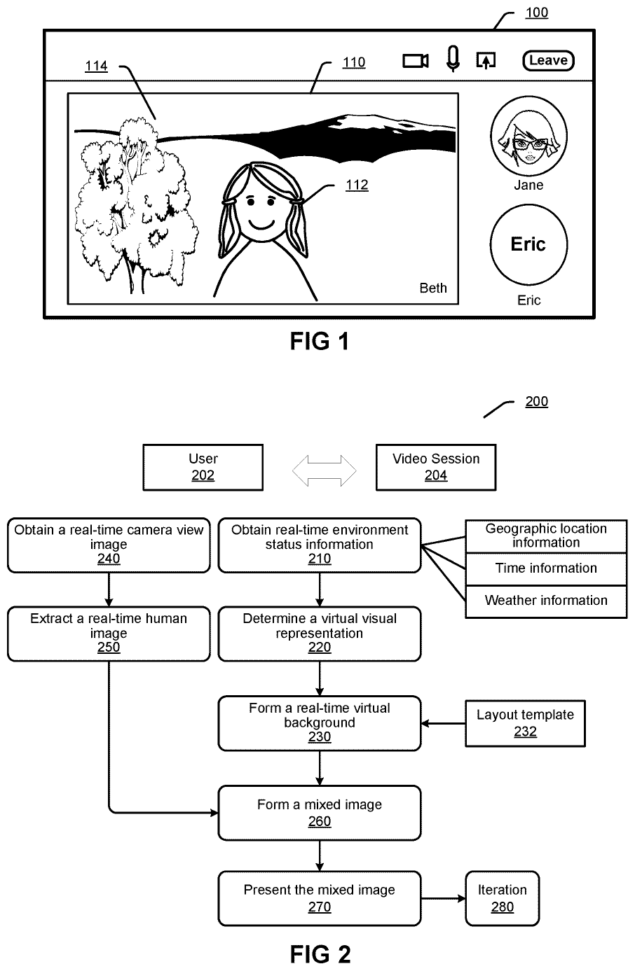

FIG. 1 illustrates an existing exemplary user interface 100 of a video session. The user interface 100 may be, e.g., a user interface of a video meeting created by a video meeting service. It is assumed that users participating in the video session in FIG. 1 include Beth, Jane and Eric. The user Beth turns on a camera of a terminal device, and the user interface 100 includes a user display region 110 corresponding to the user Beth. A real-time human image 112 of the user Beth and a predetermined background image 114 pre-selected by the user Beth are presented in the user display region 110. In the example of FIG. 1, according to the actual background image replacement function in the existing video session service, an actual background image at the user Beth's side captured by the camera is replaced by the predetermined background image 114. However, the predetermined background image 114 cannot reflect any real-time environment status information associated with the user Beth.

FIG. 2 illustrates an exemplary process 200 for providing real-time virtual background in a video session according to an embodiment. In the process 200, a user 202 is participating in a video session 204. The video session 204 may be created by a video session service, e.g., a video meeting created by a video meeting service, a group video chat created by a social networking software, etc. The video session service may provide a user interface corresponding to the video session 204 as a virtual session space accessible by multiple users participating in the video session 204.

It is assumed that the user 202 has authorized the video session service to obtain geographic location information of the user 202, turned on a camera of a terminal device of the user 202 running the video session service, and initiated a function of providing real-time virtual background in a video session according to the embodiments of the present disclosure in the video session service. Accordingly, the video session service may automatically perform various exemplary operations in the process 200.

At 210, real-time environment status information of the user 202 may be obtained. The real-time environment status information may include, e.g., at least one of geographic location information, time information, weather information, etc.

In an implementation, the obtaining of real-time environment status information at 210 may include obtaining geographic location information of the user 202. The geographic location information may be provided by the user 202 to the video session service, or may be automatically acquired by the video session service through the terminal device. The geographic location information may refer to various types of information capable of characterizing a geographic location where the user is located, e.g., country, region, city, geographic coordinates, etc. The embodiments of the present disclosure are not limited to any particular type of geographic location information, and are not limited to any specific approach of obtaining geographic location information.

In an implementation, the obtaining of real-time environment status information at 210 may include obtaining time information corresponding to the geographic location information based on the geographic location information of the user 202. The time information may refer to various types of information capable of characterizing the current time at the geographic location where the user is located. The time information may be defined based on various classification criteria. For example, the time information may indicate day, night, etc. For example, the time information may indicate early morning, morning, noon, afternoon, dusk, night, etc. For example, the time information may indicate a specific hour, minute, etc., of the day. Since different users may be in different time zones, it may be determined which time zone the user 202 is in based on the geographic location information of the user 202, and then determined the current time in the time zone. For example, assuming that the user Jane is determined to be in the time zone GMT-7 based on the geographic location information of the user Jane, and the user Beth is determined to be in the time zone GMT+8 based on the geographic location information of the user Beth, a time difference between the user Jane and the user Beth is 15 hours, i.e., when the current time corresponding to the user Jane is 8 a.m., the current time corresponding to the user Beth is 11 μm. The embodiments of the present disclosure are not limited to any specific classification criteria for time information, and are not limited to any specific approach of obtaining time information.

In an implementation, the obtaining of real-time environment status information at 210 may include obtaining weather information corresponding to the geographic location information based on the geographic location information of the user 202. The weather information may refer to various types of information capable of characterizing the current weather at the geographic location where the user is located, e.g., clear and cloudless, cloudy, overcast, rainy, snowy, etc. The weather information may be defined based on various classification criteria. The current weather information at the geographic location where the user 202 is located may be obtained on the network or from a predetermined data source. The embodiments of the present disclosure are not limited to any specific classification criteria for weather information, and are not limited to any specific approach of obtaining weather information.

At 220, a virtual visual representation corresponding to the real-time environment status information of the user 202 may be determined. Herein, a virtual visual representation may refer to various visual presentations capable of reflecting real-time environment status information. For example, the virtual visual representation may be a single image, or a video frame in a video. The virtual visual representation may be generated based at least in part on a real-world scene, or be generated entirely by computer simulation. The virtual visual representation may reflect at least one of the geographic location, the current time, the current weather, etc. associated with the user 202.

In an aspect, the geographic location where the user 202 is located may be visually reflected through including representative buildings, natural landscapes, animals, plants, etc., corresponding to the geographic location of the user 202 in the virtual visual representation. For example, assuming that the geographic location information of the user 202 indicates that the user 202 is in Beijing, China, and representative buildings in the city “Beijing” include the Great Wall, visual elements corresponding to the Great Wall may be included in the virtual visual representation to reflect that the user 202 is participating in the video session at the geographic location “Beijing”.

In an aspect, the current time may be visually reflected through making the virtual visual representation have light intensity, light angle, etc., corresponding to the current time. For example, assuming that the time information of the user 202 indicates that the current time at the user 202 is noon, the virtual visual representation may have a higher light intensity to reflect that the current time at the user 202 is noon.

In an aspect, the current weather may be visually reflected through making the virtual visual representation have the sky, light intensity, weather effects, etc., corresponding to the current weather. For example, assuming that the weather information of the user 202 indicates that the current weather at the user 202 is overcast, the virtual visual representation may have a lower light intensity and/or a larger cloud amount to reflect that the current weather at the user 202 is overcast.

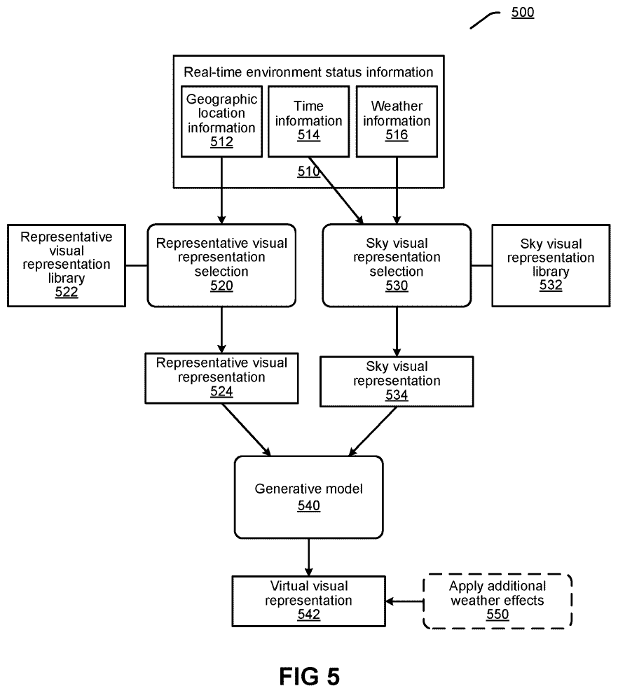

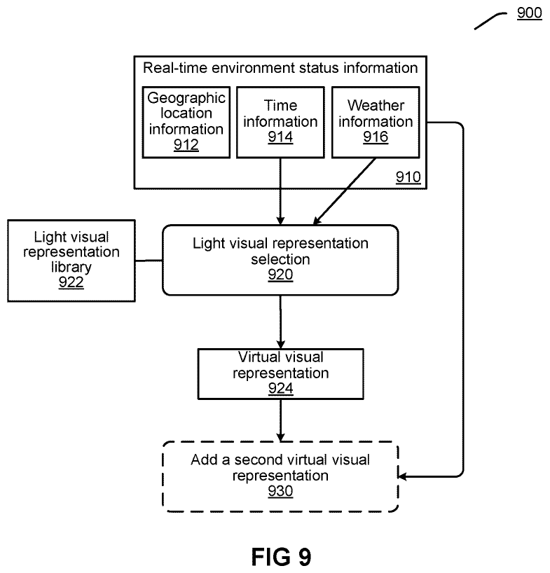

The virtual visual representation may be determined through, e.g., a generating approach, a retrieval approach, etc. In the generating approach, a virtual visual representation may be generated based at least on real-time environment status information through a machine learning model or network, as discussed below in connection with FIG. 5 to FIG. 8. In the retrieval approach, a virtual visual representation may be selected from a pre-prepared virtual visual representation library based on real-time environment status information, as discussed below in connection with FIG. 9 to FIG. 11.

At 230, a real-time virtual background may be formed with the virtual visual representation determined at 220 and a predetermined layout template 232. For example, a real-time virtual background may be formed through adding a virtual visual representation into a layout template. A layout template into which a virtual visual representation is added may be used as a real-time virtual background. A layout template is a template for specifying layout of a real-time virtual background, which may at least define an approach through which a virtual visual representation is presented, e.g., defining how a virtual visual representation is presented in a real-time virtual background.

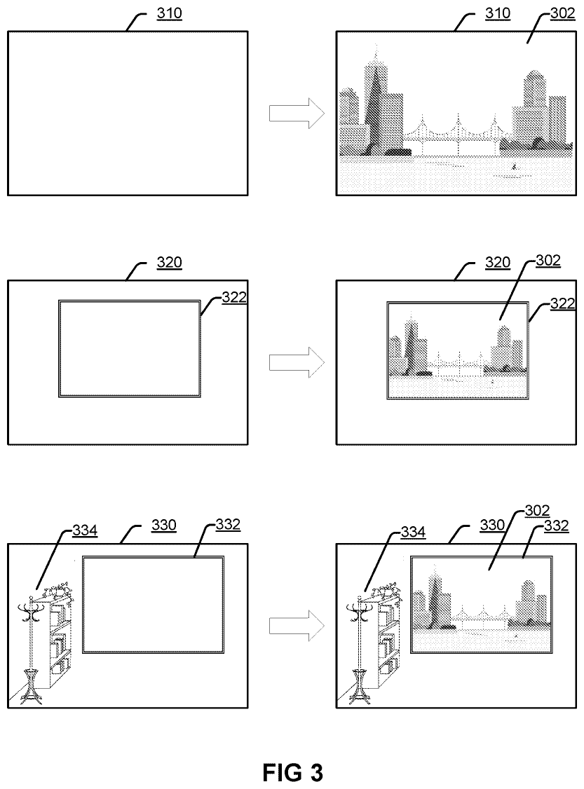

In an implementation, a layout template may define: tiling a virtual visual representation. Thus, through the tiling operation, the virtual visual representation may be used directly as a real-time virtual background, e.g., the virtual visual representation 302 may be used as the entire virtual visual background. FIG. 3 illustrates exemplary layout templates according to embodiments. As an example, a layout template 310 in FIG. 3 defines tiling a virtual visual representation. Accordingly, when the virtual visual representation 302 is added into the layout template 310, the virtual visual representation 302 may be tiled in the layout template 310.

In an implementation, a layout template may define: presenting a virtual visual representation in a predetermined presenting region in a layout template. Thus, the virtual visual representation will be presented in the predetermined presenting region in the real-time virtual background. The presenting region may have a preset size, position, appearance, etc. Optionally, the layout template may have specific visual effects. For example, the layout template may be displayed, as a whole, as a wall of a house, while the outline of the presenting region may be displayed as a window frame on the wall. As an example, a layout template 320 in FIG. 3 defines presenting a virtual visual representation in a presenting region 322. Accordingly, when the virtual visual representation 302 is added into the layout template 320, the virtual visual representation 302 may be presented in the presenting region 322. Exemplarily, the layout template 320 is displayed, as a whole, as a wall of a house, and the outline of the presenting region 322 is displayed as a window frame on the wall. Moreover, optionally, the layout template may also contain any additional visual elements in regions outside the presenting region. In one case, additional visual elements may reflect an occurring place of a user. As an example, a layout template 330 in FIG. 3 defines presenting a virtual visual representation in a presenting region 332, and the layout template 330 also includes additional visual elements 334, wherein the layout template 330 is displayed, as a whole, as a wall of a house and the outline of the presenting region 332 is displayed as a window frame on the wall. The additional visual elements 334 may include bookshelves, flowers, coat hangers, etc., for reflecting an exemplary occurring place “home” of the user. Accordingly, after adding the virtual visual representation 302 into the layout template 330, the resulting virtual background image may more vividly present the scene in which the user participates in the video session at home. In order to reflect an occurring place of the user in the virtual background image, the process 200 may also optionally include obtaining occurring place information of the user 202. For example, the user 202 may input or set occurring place information of the user participating in the video session, e.g., home, office, etc., in the video session service, whereby the occurring place information of the user 202 may be obtained based on such user input or setting. Accordingly, the layout template 232 may be a template that includes visual elements corresponding to the occurring place of the user 202. In this case, a plurality of templates respectively including visual elements corresponding to different occurring places may be prepared in advance, and in response to obtaining occurring place information of the user, a template matching the obtained occurring place information may be selected.

It should be understood that the embodiments of the present disclosure are not limited to any specific details of the layout template as described above and the exemplary layout templates shown in FIG. 3. Moreover, optionally, the process 200 may further include an operation about how to determine to adopt the layout template 232, e.g., adopting the layout template 232 by default, adopting the layout template 232 in response to a user designation from a plurality of candidate layout templates, selecting the layout template 232 from a plurality of candidate layout templates based at least on the occurring place information of the user, etc.

At 240, a real-time camera view image of the user 202 captured by a camera of a terminal device of the user 202 may be obtained. The real-time camera view image may include a real-time human image of the user 202, an actual background image of a place where the user 202 is located, etc.

At 250, a real-time human image of the user 202 may be extracted from the real-time camera view image. For example, a real-time human image and an actual background image may be distinguished in the real-time camera view image, and only the real-time human image may be extracted for subsequent operations. The embodiments of the present disclosure are not limited to any specific techniques for extracting a real-time human image.

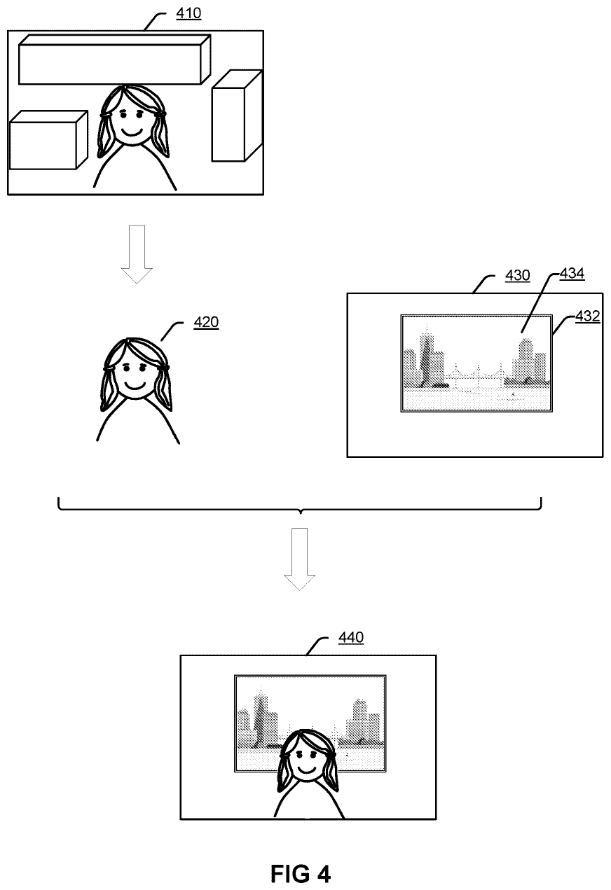

At 260, a mixed image corresponding to the user 202 may be formed with the real-time virtual background formed at 230 and the real-time human image extracted at 250. For example, a mixed image may be formed through combining a real-time virtual background and a real-time human image. Exemplarily, a real-time virtual background and a real-time human image may be combined through an image synthesis technique such as layer overlay. Optionally, a real-time virtual background and a real-time human image may be further combined according to a preset combination configuration which may specify, e.g., relative size, relative position, etc., between the real-time virtual background and the real-time human image. The embodiments of the present disclosure are not limited to any specific image synthesis technique and any specific combination configuration for combining a real-time virtual background and a real-time human image. FIG. 4 illustrates an example of forming a mixed image according to an embodiment. In FIG. 4, a real-time human image 420 may be extracted from a real-time camera view image 410 according to, e.g., the step 240 and step 250 in FIG. 2. A real-time virtual background 430 may be formed according to, e.g., the step 210, step 220 and step 230 in FIG. 2, and formed based on, e.g., the layout template 320 in FIG. 3. The real-time virtual background 430 includes at least a virtual visual representation 434 presented in a presenting region 432. The real-time human image 420 and the real-time virtual background 430 may be combined into a mixed image 440 according to, e.g., the step 260 in FIG. 2.

At 270, the mixed image formed at 260 may be presented in a user display region corresponding to the user 202 in a user interface of the video session.

In the existing video session service, a user interface of a video session may include a respective user display region corresponding to each user participating in the video session. When a user does not turn on a camera, an avatar or name of the user may be displayed in a user display region corresponding to the user, as shown in a circular user display region corresponding to the user Jane and a circular user display region corresponding to the user Eric in FIG. 1. When a user turns on a camera, a real-time camera view image captured by the camera may be displayed in a user display region corresponding to the user, as shown in a rectangular user display region 110 corresponding to the user Beth in FIG. 1.

However, unlike the existing video session service, the embodiments of the present disclosure may present, in a user display region corresponding to the user 202, the mixed image formed at 260, rather than the real-time camera view image captured by the camera of the user 202. In the mixed image, the actual background image captured by the camera has been replaced by the real-time virtual background formed at 230, thus other users participating in the video session may learn about the real-time environment status information of the user 202 through the mixed image.

It should be understood that the operations included in the process 200 as discussed above may be performed iteratively so as to continuously update the real-time virtual background and further update the mixed image. Accordingly, at 280, some or all of the operation 210 to the operation 270 in the process 200 may begin to be iteratively performed. In each iteration, updated real-time environment status information of the user 202 may be obtained. For example, the time and/or weather at the user 202 may have changed, resulting in updated real-time environment status information. An updated virtual visual representation corresponding to the updated real-time environment status information may be determined. For example, when the current time at the user 202 changes from day to night, the previous virtual visual representation reflecting the time “day” may change to a virtual visual representation reflecting the current time “night”. For example, when the current weather at the user 202 changes from cloudy to rainy, the previous virtual visual representation reflecting the weather “cloudy” may change to a virtual visual representation reflecting the current weather “rainy”. An updated real-time virtual background may be formed through adding the updated virtual visual representation into the layout template 232. An updated mixed image corresponding to the user 202 may be formed through combining the updated real-time virtual background and the real-time human image of the user 202. The updated mixed image may be presented in the user display region corresponding to the user 202. Thus, the update of the real-time virtual background may enable other users participating in the video session to learn about changes of the real-time environment status information of the user 202 in time.

It should be understood that all the operations or steps in the process 200 as described above in connection with FIG. 2 are exemplary, and depending on specific application scenarios and requirements, the process 200 may include more or less operations or steps. The embodiments of the present disclosure will cover changes to the process 200 in any approach.

FIG. 5 illustrates an exemplary process 500 for determining a virtual visual representation according to an embodiment. The process 500 is an exemplary implementation of the operation 220 in FIG. 2. The process 500 may be performed for determining a virtual visual representation through a generating approach. It is assumed that real-time environment status information 510 has been obtained before the process 500 is performed.

At 520, representative visual representation selection may be performed. For example, at 520, a representative visual representation 524 corresponding to geographic location information 512 in the real-time environment status information 510 may be selected from a geographic location-based representative visual representation library 522. Herein, a representative visual representation may be associated with a geographic location, and a specific representative visual representation associated with a specific geographic location may include representative buildings, natural landscapes, animals, plants, etc., at this specific geographic location, so as to visually reflect this specific geographic location. For example, representative buildings of the city “Beijing” include the Great Wall, etc., and thus, a representative visual representation associated with Beijing may be a visual representation presenting “the Great Wall”, etc. A representative visual representation may be an image, or a video image frame in a video. The representative visual representation library 522 may be pre-prepared, which may include a large number of candidate representative visual representations corresponding to different geographic locations. Preferably, in order to enhance realness, the candidate representative visual representations in the representative visual representation library 522 may be real-world photos or videos that are actually shot. Moreover, the candidate representative visual representations in the representative visual representation library 522 may be photos or videos containing the sky. At 530, sky visual representation selection may be performed. For example, at 530, a sky visual representation 534 corresponding to time information 514 and/or weather information 516 in the real-time environment status information 510 may be selected from a time and/or weather-based sky visual representation library 532. Herein, a sky visual representation may be associated with time and/or weather, and a specific sky visual representation associated with a specific time and/or weather may include various visual elements for visually reflecting this specific time and/or weather, e.g., cloud amount, cloud color, sky light intensity, etc. In an aspect, a sky visual representation may reflect the current time, e.g., different sky light intensities from high to low may indicate noon, afternoon, dusk, etc. respectively, morning glow may indicate morning, sunset glow may indicate dusk, and so on. In another aspect, a sky visual representation may reflect the current weather, e.g., a sky with no or few clouds may indicate clear, a sky with a large cloud amount may indicate cloudy, a sky with a large cloud amount and dim clouds may indicate overcast, a higher sky light intensity may indicate clear, a lower sky light intensity may indicate cloudy, etc. Moreover, a sky visual representation may also reflect the current time and the current weather at the same time, e.g., a small amount of sunset glow may indicate dusk and clear, a sky with a large cloud amount and a low light intensity may indicate afternoon and cloudy, etc. A sky visual representation may be an image, or a video image frame in a video. The sky visual representation library 532 may be pre-prepared, which may include a large number of candidate sky visual representations corresponding to different times and/or weathers. Preferably, in order to enhance realness, the candidate sky visual representations in the sky visual representation library 532 may be real-world photos or videos, etc. that are actually shot. Moreover, preferably, the candidate sky visual representations in the sky visual representation library 532 may have a wide field of view, e.g., 360-degree candidate sky visual representations, etc.

The process 500 may generate a virtual visual representation 542 based at least on the representative visual representation 524 and the sky visual representation 534. In an implementation, a previously-trained generative model 540 may be adopted for generating the virtual visual representation 542 based on the representative visual representation 524 and the sky visual representation 534. The generative model 540 may replace a sky in the representative visual representation 524 with at least the sky visual representation 534, so that the resulting virtual visual representation 542 may reflect not only geographic location information, but also time information and/or weather information.

As an example, an exemplary generative model 540 may include a sky matting module, a motion estimating module, a fusion module, etc.

Take the representative visual representation being a video image frame in a video as an example. The sky matting module may process the representative visual representation frame by frame in a chronological order, to obtain a position of the sky in each frame of image. In an implementation, the sky matting module may include an encoder, and the encoder may be built based on, e.g., a deep residual network (e.g., ResNet50), and may perform feature extraction on an input image. The sky matting module may also include a prediction decoder, and the prediction decoder may be built based on, e.g., a U-Net network, and may predict a position of the sky in an input image. Preferably, the sky matting module may further include a fine-tuning module, and the fine-tuning module may be built based on, e.g., guided filtering technique, and may be used for fine-tuning the position of the sky predicted by the prediction decoder. For example, the fine-tuning module may filter out red and green channels in each frame of RGB image, while retaining a blue channel that matches the color of the sky. Accordingly, the sky matting module may finally obtain a sky matte for the input image.

The motion estimating module may estimate motion trajectories of objects in the sky (e.g., clouds, sun, moon, etc.) for use in the subsequent fusion module. Object motions in the sky may be modeled with an affine matrix. For example, the motion estimating module may compute optical flow in an input image by using, e.g., the Lucas-Kanade method on an image pyramid, track feature points in the sky region frame by frame, and obtain an affine matrix reflecting motions of objects in the sky over time through making comparison between every two adjacent frames.

The fusion module may generate the virtual visual representation 542 based on the representative visual representation 524, the sky visual representation 534, the sky matte, motion parameters in the affine matrix, etc. For example, the fusion module may utilize sky matting to replace the sky in the representative visual representation 524 by the sky visual representation 534, and may utilize the motion parameters in the affine matrix to make objects in the sky in the sky visual representation 534 to simulate the motions of objects in the sky in the representative visual representation 524. Moreover, preferably, the fusion module may also migrate color, light intensity, etc., in the sky visual representation 534 to the representative visual representation 524, to make color, light intensity, etc., of each part in the finally obtained virtual visual representation 542 more coordinated.

It should be understood that the specific implementation of the generative model 540 is not limited to any technical details as described above, but the generative model 540 may be implemented through making any change, replacement, or removal to these technical details.

The generative model 540 may adopt any known or soon to be known machine learning techniques. Moreover, the generative model 540 may also be trained with any common training approach.

The process 500 may also optionally include applying additional weather effects to the virtual visual representation 542 at 550 so as to better reflect specific weather, e.g., rainy, snowy, etc.

Taking a weather “rainy” as an example, in order to enhance the expression of “rain” by the virtual visual representation 542, an image containing visual elements similar to raindrops may be superimposed on the virtual visual representation 542, so that the final virtual visual representation 542 will contain at least the visual elements “raindrops”, thereby better reflecting the weather “rainy”.

It should be understood that all the operations or steps in the process 500 as described above in connection with FIG. 5 are exemplary, and depending on specific application scenarios and requirements, the process 500 may include more or less operations or steps. The embodiments of the present disclosure will cover changes to the process 500 in any approach. For example, instead of adopting the generative model 540, the embodiments of the present disclosure may adopt any other model or technique capable of generating the virtual visual representation 542 based at least on the representative visual representation 524 and the sky visual representation 534. Moreover, the process 500 may cause the virtual visual representation 542 to have the same data format as the representative visual representation 524 and/or the sky visual representation 534. For example, when the representative visual representation 524 and/or the sky visual representation 534 are images, the virtual visual representation 542 may be generated as an image, and when the representative visual representation 524 and/or the sky visual representation 534 are videos, the virtual visual representation 542 may be generated as a video. Moreover, through performing the process 500 iteratively, an updated virtual visual representation may be continuously generated in response to changes in the real-time environment status information.

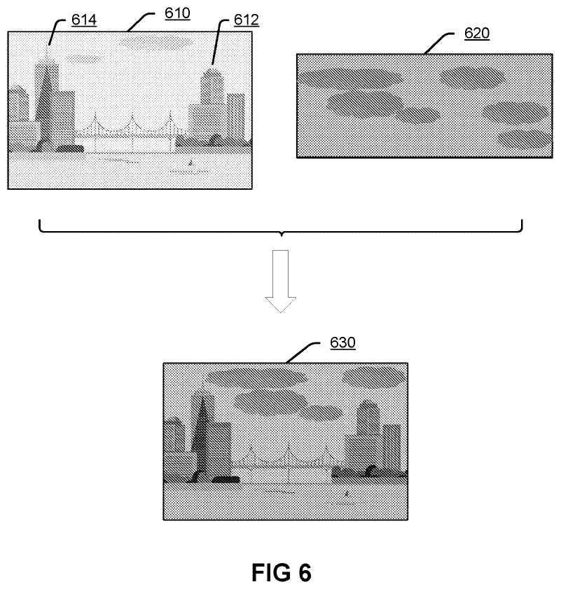

FIG. 6 illustrates an example of a virtual visual representation according to an embodiment. The virtual visual representation in FIG. 6 may be generated through, e.g., the process 500 in FIG. 5. It is assumed that geographic location information in real-time environment status information indicates a city A, and weather information in the real-time environment status information indicates the weather “overcast”. A representative visual representation 610 corresponding to the city A may be selected, e.g., at 520 in FIG. 5, from a representative visual representation library that includes representative buildings 612 and 614 of the city A and has the weather “clear”. A sky visual representation 620 corresponding to the weather “overcast” may be selected, e.g., at 530 in FIG. 5, from a sky visual representation library that includes a large cloud amount and has a low light intensity.

A virtual visual representation 630 may be generated based at least on the representative visual representation 610 and the sky visual representation 620 through, e.g., the generative model 540 in FIG. 5. As shown, the virtual visual representation 630 includes not only representative buildings 612 and 614 of the city A, but also a large amount of clouds in the sky. Moreover, the overall light intensity of the virtual visual representation 630 is low. Thus, the virtual visual representation 630 visually reflects the geographic location information “city A”, the weather information “overcast”, etc., in the real-time environment status information.

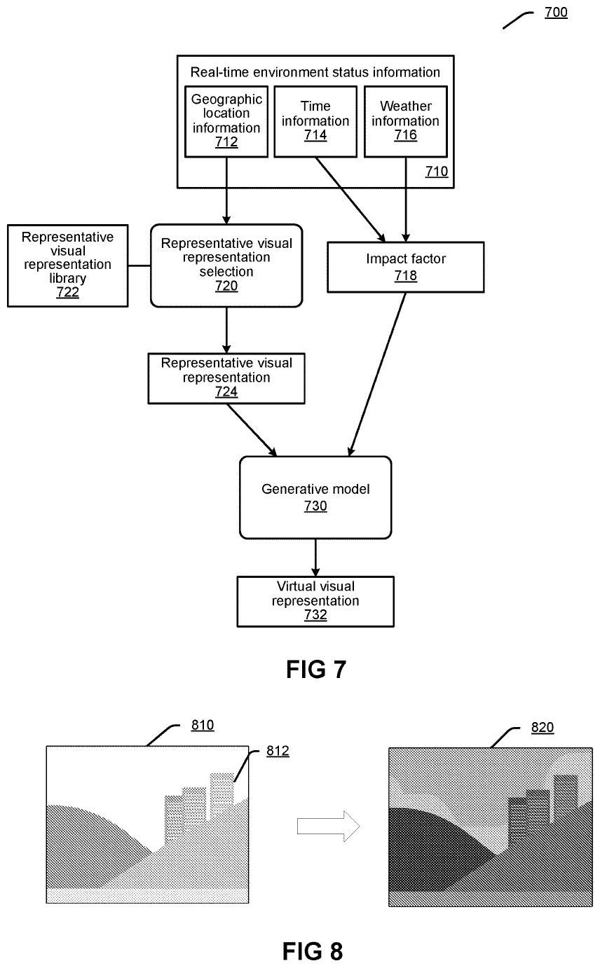

FIG. 7 illustrates an exemplary process 700 for determining a virtual visual representation according to an embodiment. The process 700 is an exemplary implementation of the operation 220 in FIG. 2. The process 700 may be performed for determining a virtual visual representation through a generating approach. It is assumed that real-time environment status information 710 has been obtained before the process 700 is performed.

At 720, representative visual representation selection may be performed. For example, at 720, a representative visual representation 724 corresponding to geographic location information 712 in real-time environment status information 710 may be selected from a geographic location-based representative visual representation library 722. The representative visual representation selection at 720 may be similar to the representative visual representation selection at 520 in FIG. 5.

The process 700 may generate a virtual visual representation 732 based on a representative visual representation 724 through taking time information 714 and/or weather information 716 in the real-time environment status information 710 as an impact factor 718. In an implementation, a previously-trained generative model 730 may be adopted for generating the virtual visual representation 732 based on the representative visual representation 724 under the influence of the impact factor 718. Unlike the generative model 540 in FIG. 5, the generative model 730 does not need to perform any separate processing on the sky. Thus, the representative visual representation 724 which is an input to the generative model 730 does not necessarily contain a sky part, and it may also contain no sky, or contain only a small portion of the sky, etc. Since the virtual visual representation 732 is generated with at least the impact factor 718 and the representative visual representation 724, it can reflect not only geographic location information, but also time information and/or weather information.

As an example, an exemplary generative model 730 may be a weather Generative Adversarial Network (GAN) model built based on a GAN, which is trained for generating a virtual visual representation based on a representative visual representation under the influence of a weather-related impact factor. The weather GAN model may convert an original weather category of an input image into a target weather category. For example, the weather GAN model may utilize various weather cues for determining a weather condition of the input image, wherein the weather cues may include, e.g., wet ground, raindrops, snowflakes, cloud covering, blue sky, etc. The weather GAN model may focus the main attention on the weather cues during the weather category conversion process, e.g., converting the parts related to the weather cues in the input image to the target weather category, while keeping the other parts unchanged. The generative adversarial network adopted by the weather GAN model may include a generator and a discriminator. During training, the generator may be used for generating an image, and the discriminator may be used for judging the realness degree of the generated image.

The generator may include an initial translation module, an attention module, a weather cue segmentation module, etc. These modules in the generator may be based on a pixel-to-pixel network, which may be implemented as a network model structure similar to UNet. The initial translation module may globally translate an input image so as to obtain preliminary features of the input image. The attention module may apply an attention mechanism to the input image so as to reinforce weather-related regions in the input image and equalize the overall style among different regions, and accordingly, the attention module may predict a spatial attention map. The weather cue segmentation module may segment the weather clues from the input image and generate a weather cue segmentation map. The spatial attention map output by the attention module and the weather cue segmentation map output by the weather cue segmentation module may be combined into a translation map which may characterize the weather cues under the attention mechanism. Finally, through combining the input image, the translation map, and the preliminary features of the input image obtained by the initial translation module, an image finally produced by the generator may be obtained.

During training, an image produced by the generator and a real image having a target weather category may be input into the discriminator together. The discriminator may judge whether an image is real or fake, and may further improve the performance of the generator and the discriminator through back-propagation.

During practical application, the trained generator may be directly used for generating a desired image without using the discriminator. The weather information in the real-time environment status information may be used as an impact factor for the generator, for indicating a target weather category. Accordingly, the generator will generate, based on an input image (e.g., a representative visual representation), an output image (e.g., a virtual visual representation) having the target weather category indicated by the impact factor.

It should be understood that the weather GAN model as described above is only an exemplary implementation of the generative model 730. Although this weather GAN model only takes weather information as an impact factor, a further model may be built in a similar approach for generating a virtual visual representation with either or both weather information and time information as an impact factor. The embodiments of the present disclosure are not limited to any specific implementation of the generative model 730 or any specific technical details. The generative model 730 may adopt any known or soon to be known machine learning techniques.

Moreover, the generative model 730 may also be trained with any common training approach. It should be understood that all the operations or steps in the process 700 as described above in connection with FIG. 7 are exemplary, and depending on specific application scenarios and requirements, the process 700 may include more or less operations or steps. The embodiments of the present disclosure will cover changes to the process 700 in any approach. For example, instead of adopting the generative model 730, the embodiments of the present disclosure may adopt any other model or technique capable of generating the virtual visual representation 732 based on the representative visual representation 724 through taking the time information 714 and/or the weather information 716 as an impact factor. Moreover, the process 700 may cause the virtual visual representation 732 to have the same data format as the representative visual representation 724. Moreover, through performing the process 700 iteratively, an updated virtual visual representation may be continuously generated in response to changes in the real-time environment status information.

FIG. 8 illustrates an example of a virtual visual representation according to an embodiment. The virtual visual representation in FIG. 8 may be generated through, e.g., the process 700 in FIG. 7. It is assumed that geographic location information in real-time environment status information indicates a city A, weather information in the real-time environment status information indicates the weather “overcast”, and time information in the real-time environment status information indicates the time “dusk”. A representative visual representation 810 corresponding to the city A may be selected, e.g., at 720 in FIG. 7, from a representative visual representation library that includes a representative building 812 of the city A. The representative visual representation 810 has a “clear” weather and a high light intensity.

A virtual visual representation 820 may be generated based on the representative visual representation 810 through taking the weather information “overcast” and the time information “dusk” as an impact factor, by using, e.g., the generative model 730 in FIG. 7. As shown, the virtual visual representation 820 contains the representative building 812 of the city A, and the overall light intensity of the virtual visual representation 820 is low. Thus, the virtual visual representation 820 visually reflects the geographic location information “city A”, the weather information “overcast”, the time information “dusk”, etc., in the real-time environment status information.

FIG. 9 illustrates an exemplary process 900 for determining a virtual visual representation according to an embodiment. The process 900 is an exemplary implementation of the operation 220 in FIG. 2. The process 900 may be performed for determining a virtual visual representation through a retrieval approach. It is assumed that real-time environment status information 910 has been obtained before the process 900 is performed.

At 920, light visual representation selection may be performed. For example, at 920, a light visual representation corresponding to time information 914 and/or weather information 916 in the real-time environment status information 910 may be selected from a time and/or weather-based light visual representation library 922, as a virtual visual representation 924. Herein, a light visual representation may be associated with time and/or weather, and a specific light visual representation associated with a specific time and/or weather may visually reflect the specific time and/or weather through light angle, light intensity, etc. As an example, it is assumed that the light visual representation displays a scene that includes a window in a house. At different times, light angle and/or light intensity at which sunlight shines from outside the house into the house through the window will also be different. Thus, at least different light angles and/or light intensities may be utilized in the light visual representation for reflecting different times. Moreover, in different weathers, light intensity at which sunlight shines from outside the house into the house through the window will also be different, e.g., a “clear” weather has a high light intensity and a “overcast” weather has a low light intensity. Therefore, at least different light intensities may be utilized in the light visual representation for reflecting different weathers.

The light visual representation library 922 may be pre-prepared, which may include a large number of candidate light visual representations corresponding to different times and/or weathers in a specific scene. In an implementation, a 3D modeling software may be used first for modeling a house, e.g., creating an isometric model of the current level ground, house, and windows. A sun model may be set up in a high dynamic range image (HDRI). By changing different azimuths and/or elevations of the sun in the HDRI, sunlight shining states from morning to night in the real world environment may be simulated. A virtual camera may be set at a specific position in the house for capturing the scene in which sunlight shines from outside the house into the house through the window, including projection of the window on a wall that can reflect the light angle, the light intensity in the house, etc. Composition may be made according to a predetermined effect, and positions of different azimuths and/or altitudes of the sun are marked in an animation timeline. A renderer may be utilized for scene rendering, so as to obtain a series of rendered frames across time, e.g., one rendered frame per hour, etc. These rendered frames may form an output scene sequence and are stored in the light visual representation library 922 as candidate light visual representations. Each candidate light visual representation may correspond to a specific time.

It should be understood that although in the above example the candidate light visual representations are generated only in consideration of time, the candidate light visual representations may also be generated in consideration of weather or both time and weather. For example, in different weathers, the renderer may render the scene with different light intensities, so that the light intensity in the rendered frame may change along with different weathers. Moreover, it should be understood that the light visual representation library 922 may also include multiple scenes and multiple candidate light visual representations under each scene. Thus, candidate light visual representations in different scenes may be selected for different users, thereby enhancing variety and personalization.

According to the process 900, since the light visual representation library 922 is built based on time and/or weather, when the time information 914 and/or the weather information 916 in the real-time environment status information 910 changes, a new light visual representation corresponding to the changed time information and/or weather information may be selected in time from the light visual representation library 922, as an updated virtual visual representation. Moreover, in order to further enhance the reflection of real-time environment status information, the process 900 may optionally further include adding a second virtual visual representation into the virtual visual representation 924 at 930. For example, a second virtual visual representation corresponding to the real-time environment status information 910 may be added within a predetermined presenting region in the virtual visual representation 924. The second virtual visual representation may be a virtual visual representation generated through, e.g., the process 500 in FIG. 5 or the process 700 in FIG. 7. The predetermined presenting region in the virtual visual representation 924 may refer to a region suitable for presenting the second virtual visual representation, e.g., a window, etc. Thus, the virtual visual representation 924 into which the second virtual visual representation is added may then reflect the real-time environment status information 910 through the second virtual visual representation.

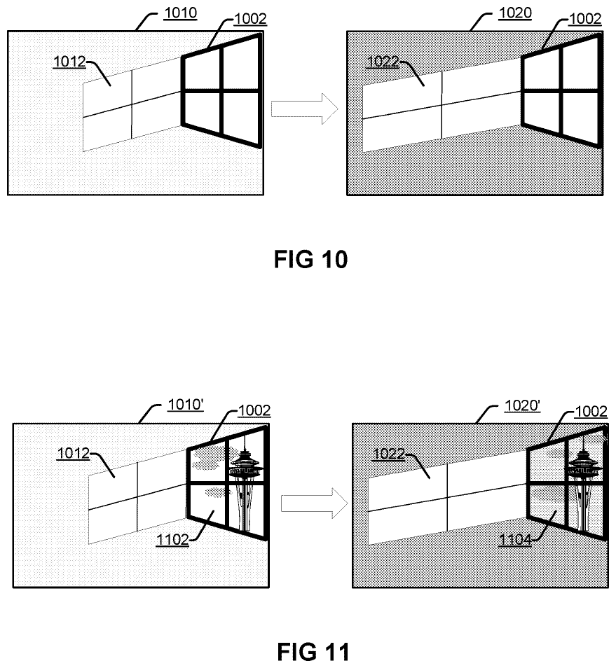

FIG. 10 illustrates examples of virtual visual representations according to an embodiment. The virtual visual representations in FIG. 10 may be retrieved through, e.g., the process 900 in FIG. 9. It is assumed that a virtual visual representation 1010 is selected from a light visual representation library based on the time information “1 p.m.”. The virtual visual representation 1010 includes a window 1002 and a projection 1012 of the window 1002 on a wall. The angle of the projection 1012 corresponds to the position of the sun at the current time “1 p.m.”.

As time goes by, when the time information becomes to “5 p.m.”, a virtual visual representation 1020 may be selected from the light visual representation library. The virtual visual representation 1020 has the same scene as the virtual visual representation 1010, e.g., the same composition including the window 1002. However, compared with the projection 1012 of the window 1002 on the wall in the virtual visual representation 1010, the projection 1022 of the window 1002 on the wall in the virtual visual representation 1020 is closer to a horizontal angle. The angle of the projection 1022 corresponds to the position of the sun at the current time “5 p.m.”. Moreover, the virtual visual representation 1020 has a lower light intensity than the virtual visual representation 1010, so as to reflect the change of the time.

FIG. 11 illustrates examples of virtual visual representations according to an embodiment. The virtual visual representations in FIG. 11 may be produced through, e.g., the process 900 in FIG. 9. Moreover, the virtual visual representations in FIG. 11 may be formed through adding second virtual visual representations into the virtual visual representations in FIG. 10.

A virtual visual representation 1010′ is formed on the basis of the virtual visual representation 1010 in FIG. 10. The virtual visual representation 1010′ includes a second virtual visual representation 1102 added in the window 1002 which is a presenting region. The second virtual visual representation 1102 may be generated through, e.g., the process 500 in FIG. 5 or the process 700 in FIG. 7, which reflects at least one of geographic location information, time information and weather information in the real-time environment status information. A virtual visual representation 1020′ is formed on the basis of the virtual visual representation 1020 in FIG. 10. The virtual visual representation 1020′ includes a second virtual visual representation 1104 added in the window 1002 which is a presenting region. The second virtual visual representation 1104 may be updated from the second virtual visual representation 1102 through, e.g., the process 500 in FIG. 5 or the process 700 in FIG. 7, which reflects at least one of geographic location information, time information and weather information in the updated real-time environment status information.

It should be understood that although in the examples as described above in connection with FIG. 10 and FIG. 11, the virtual visual representations are selected from a light visual representation library based on time information, in the case that the light visual representation library is built based on weather or both time and weather, virtual visual representations may also be selected from the light visual representation library accordingly based on weather information or both time information and weather information.

It should be understood that although exemplary implementations of determining a virtual visual representation at the operation 220 in FIG. 2 are discussed above in connection with FIG. 5, FIG. 7 and FIG. 9, the embodiments of the present disclosure are not limited to these exemplary implementations, but may encompass any other implementation capable of determining a virtual visual representation corresponding to real-time environment status information.

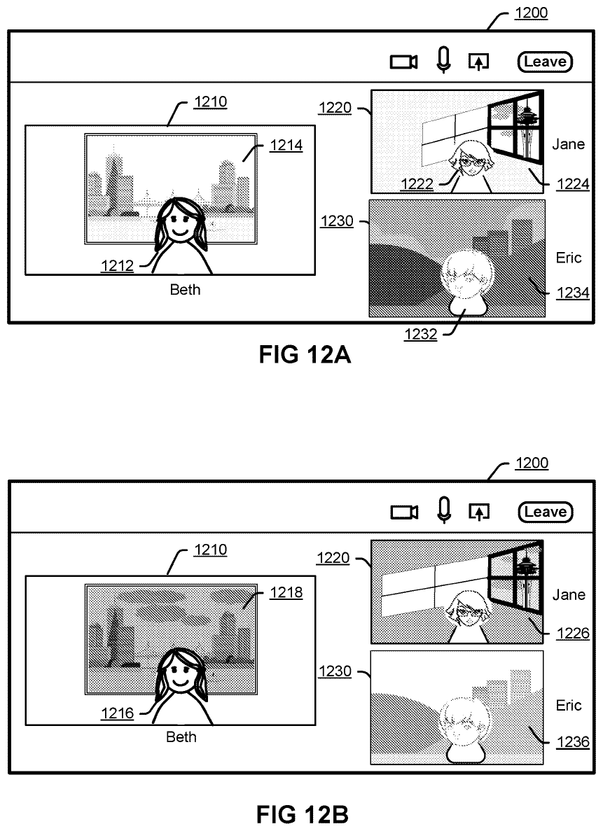

FIG. 12A and FIG. 12B illustrate an exemplary user interface 1200 of a video session according to an embodiment. The user interface 1200 may be, e.g., a user interface for a video meeting created by a video meeting service. It is assumed that users participating in the video session include Beth, Jane and Eric. All of the users Beth, Jane and Eric turn on cameras of their terminal devices, authorize the video session service to obtain user geographic location information, and initiate, in the video session service, the function of providing real-time virtual background in a video session according to the embodiments of the present disclosure.

As shown in FIG. 12A, the user interface 1200 includes a user display region 1210 corresponding to the user Beth. A mixed image generated according to the embodiments of the present disclosure is currently displayed in the user display region 1210. The mixed image includes a real-time human image 1212 of the user Beth and a real-time virtual background generated according to the embodiments of the present disclosure. The real-time virtual background includes at least a virtual visual representation 1214 determined according to the embodiments of the present disclosure. Exemplarily, the real-time virtual background may be formed according to, e.g., the layout template 320 in FIG. 3. As shown, the virtual visual representation 1214 visually reflects the real-time environment status information of the user Beth, e.g., reflecting a geographic location of the user Beth through a representative building, reflecting the current weather “clear” and/or the current time “noon” at the geographic location of the user Beth through the sky, light intensity, etc. Moreover, as shown in FIG. 12A, the user interface 1200 includes a user display region 1220 corresponding to the user Jane. A mixed image generated according to the embodiments of the present disclosure is currently displayed in the user display region 1220, wherein the mixed image includes a real-time human image 1222 of the user Jane and a real-time virtual background generated according to the embodiments of the present disclosure, and the real-time virtual background includes at least a virtual visual representation 1224 determined according to the embodiments of the present disclosure. Exemplarily, the real-time virtual background of the user Jane may be formed according to, e.g., the layout template 310 in FIG. 3, and the virtual visual representation 1224 may be formed according to, e.g., the example of FIG. 11. The virtual visual representation 1224 visually reflects the real-time environment status information of the user Jane, e.g., reflecting a geographic location of the user Jane through a representative building, reflecting the current weather “overcast” at the geographic location of the user Jane through the sky, light intensity, etc., reflecting the current time “afternoon” at the geographic location of the user Jane through a projection of a window on a wall and light intensity, etc. Moreover, as shown in FIG. 12A, the user interface 1200 includes a user display region 1230 corresponding to the user Eric. A mixed image generated according to the embodiments of the present disclosure is currently displayed in the user display region 1230, wherein the mixed image includes a real-time human image 1232 of the user Eric and a real-time virtual background generated according to the embodiments of the present disclosure, and the real-time virtual background includes at least a virtual visual representation 1234 determined according to the embodiments of the present disclosure. Exemplarily, the real-time virtual background of the user Eric may be formed according to, e.g., the layout template 310 in FIG. 3, and the virtual visual representation 1234 may be formed according to, e.g., the example of FIG. 8. The virtual visual representation 1234 visually reflects the real-time environment status information of the user Eric, e.g., reflecting a geographic location of the user Eric through a representative building, reflecting the current weather “overcast” and/or the current time “afternoon” at the geographic location of the user Eric through light intensity, etc.

Assuming that real-time environment status information of the users Beth, Jane and Eric changes as the video session goes on, FIG. 12B shows an updated mixed image presented in a user display region of each user in response to changes in real-time environment status information. It is assumed that the weather at the geographic location of the user Beth changes from “clear” to “overcast” and the time changes from “noon” to “afternoon”. The updated mixed image presented in the user display region 1210 corresponding to the user Beth includes a real-time human image 1216 of the user Beth and an updated real-time virtual background generated according to the embodiments of the present disclosure, wherein the updated real-time virtual background includes at least an updated virtual visual representation 1218 determined according to the embodiments of the present disclosure. The updated real-time virtual background of the user Beth still adopts, e.g., the layout template 320 in FIG. 3. As shown, the updated virtual visual representation 1218 visually reflects the changed real-time environment status information of the user Beth, e.g., reflecting the current weather “overcast” and/or the current time “afternoon” through the sky, light intensity, etc. Moreover, as shown in FIG. 12B, an updated mixed image presented in the user display region 1220 corresponding to the user Jane includes at least an updated virtual visual representation 1226 which reflects at least that the time at the geographic location of the user Jane changes from “afternoon” to “dusk” etc. Moreover, as shown in FIG. 12B, an updated mixed image presented in the user display region 1230 corresponding to the user Eric includes at least an updated virtual visual representation 1236 which reflects at least that the weather at the geographic location of the user Eric changes from “overcast” to “clear” etc.

It should be understood that all the elements in the user interface as discussed above in connection with FIG. 12A and FIG. 12B are exemplary, and the embodiments of the present disclosure are not limited to any specific layout of a user interface, and are not limited to any specific approach of presenting a mixed image in a user interface.

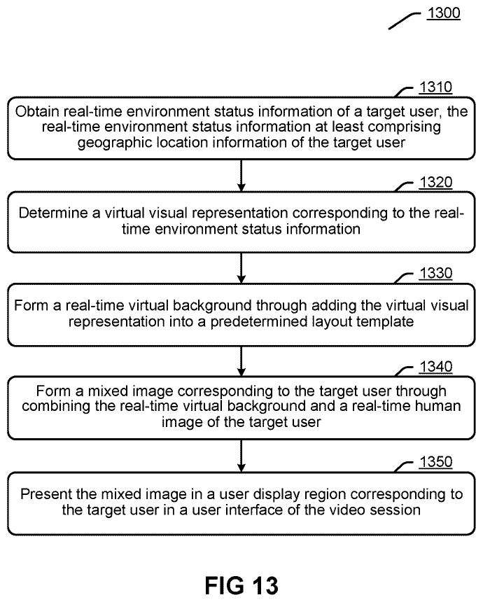

FIG. 13 illustrates a flowchart of an exemplary method 1300 for providing real-time virtual background in a video session according to an embodiment.

At 1310, real-time environment status information of a target user may be obtained, the real-time environment status information at least comprising geographic location information of the target user.

At 1320, a virtual visual representation corresponding to the real-time environment status information may be determined.

At 1330, a real-time virtual background may be formed through adding the virtual visual representation into a predetermined layout template.

At 1340, a mixed image corresponding to the target user may be formed through combining the real-time virtual background and a real-time human image of the target user.

At 1350, the mixed image may be presented in a user display region corresponding to the target user in a user interface of the video session.

In an implementation, the real-time environment status information may further comprise: time information corresponding to the geographic location information; and/or weather information corresponding to the geographic location information.

In an implementation, the virtual visual representation may be an image or a video frame.

In an implementation, the determining a virtual visual representation may comprise: selecting a representative visual representation corresponding to the geographic location information from a geographic location-based representative visual representation library; selecting a sky visual representation corresponding to time information and/or weather information in the real-time environment status information from a time and/or weather-based sky visual representation library; and generating the virtual visual representation based at least on the representative visual representation and the sky visual representation.

In an implementation, the determining a virtual visual representation may comprise: selecting a representative visual representation corresponding to the geographic location information from a geographic location-based representative visual representation library; and generating the virtual visual representation based on the representative visual representation through taking time information and/or weather information in the real-time environment status information as an impact factor.

In an implementation, the determining a virtual visual representation may comprise: selecting a light visual representation corresponding to time information and/or weather information in the real-time environment status information from a time and/or weather-based light visual representation library, as the virtual visual representation.

The method 1300 may further comprise: adding a second virtual visual representation corresponding to the real-time environment status information in a predetermined presenting region in the virtual visual representation.

In an implementation, the predetermined layout template may at least define at least one of the following approaches for presenting the virtual visual representation: tiling the virtual visual representation; and presenting the virtual visual representation in a predetermined presenting region in the predetermined layout template.

In an implementation, the method 1300 may further comprise: obtaining occurring place information of the target user. The predetermined layout template may comprise visual elements corresponding to the occurring place information.

In an implementation, the method 1300 may further comprise: obtaining a real-time camera view image of the target user captured by a camera; and extracting the real-time human image of the target user from the real-time camera view image.

In an implementation, the method 1300 may further comprise iteratively performing the following operations: obtaining updated real-time environment status information of the target user; determining an updated virtual visual representation corresponding to the updated real-time environment status information; forming an updated real-time virtual background through adding the updated virtual visual representation into the predetermined layout template; forming an updated mixed image corresponding to the target user through combining the updated real-time virtual background and a real-time human image of the target user; and presenting the updated mixed image in the user display region.

It should be understood that the method 1300 may further comprise any step/process for providing real-time virtual background in a video session according to the above embodiments of the present disclosure.

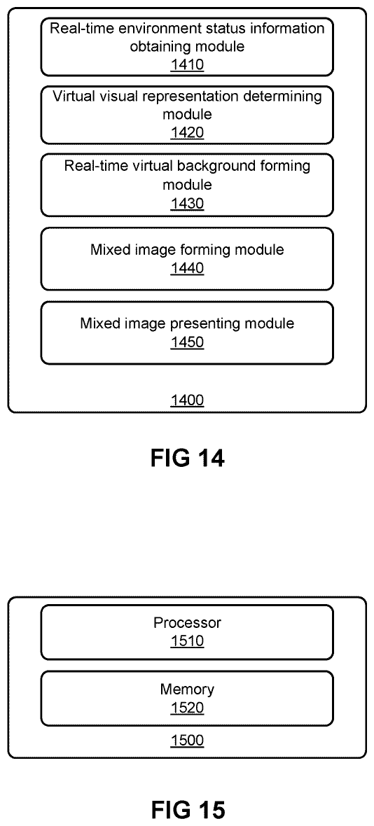

FIG. 14 illustrates an exemplary apparatus 1400 for providing real-time virtual background in a video session according to an embodiment.

The apparatus 1400 may include: a real-time environment status information obtaining module 1410, for obtaining real-time environment status information of a target user, the real-time environment status information at least comprising geographic location information of the target user; a virtual visual representation determining module 1420, for determining a virtual visual representation corresponding to the real-time environment status information; a real-time virtual background forming module 1430, for forming a real-time virtual background through adding the virtual visual representation into a predetermined layout template; a mixed image forming module 1440, for forming a mixed image corresponding to the target user through combining the real-time virtual background and a real-time human image of the target user; and a mixed image presenting module 1450, for presenting the mixed image in a user display region corresponding to the target user in a user interface of the video session. Moreover, the apparatus 1400 may further comprise any other module that is configured for performing any step/process of the methods for providing real-time virtual background in a video session according to the above embodiments of the present disclosure.

FIG. 15 illustrates an exemplary apparatus 1500 for providing real-time virtual background in a video session according to an embodiment.

The apparatus 1500 may comprise at least one processor 1510. The apparatus 1500 may further comprise a memory 1520 connected with the at least one processor 1510. The memory 1520 may store computer-executable instructions that, when executed, cause the at least one processor 1510 to: obtain real-time environment status information of a target user, the real-time environment status information at least comprising geographic location information of the target user; determine a virtual visual representation corresponding to the real-time environment status information; form a real-time virtual background through adding the virtual visual representation into a predetermined layout template; form a mixed image corresponding to the target user through combining the real-time virtual background and a real-time human image of the target user; and present the mixed image in a user display region corresponding to the target user in a user interface of the video session.

In an implementation, the determining a virtual visual representation may comprise: selecting a representative visual representation corresponding to the geographic location information from a geographic location-based representative visual representation library; selecting a sky visual representation corresponding to time information and/or weather information in the real-time environment status information from a time and/or weather-based sky visual representation library; and generating the virtual visual representation based at least on the representative visual representation and the sky visual representation.

In an implementation, the determining a virtual visual representation may comprise: selecting a representative visual representation corresponding to the geographic location information from a geographic location-based representative visual representation library; and generating the virtual visual representation based on the representative visual representation through taking time information and/or weather information in the real-time environment status information as an impact factor.

In an implementation, the determining a virtual visual representation may include: selecting a light visual representation corresponding to time information and/or weather information in the real-time environment status information from a time and/or weather-based light visual representation library, as the virtual visual representation.

The computer-executable instructions, when executed, may further cause the at least one processor 1510 to: add a second virtual visual representation corresponding to the real-time environment status information in a predetermined presenting region in the virtual visual representation.

In an implementation, the predetermined layout template may at least define at least one of the following approaches for presenting the virtual visual representation: tiling the virtual visual representation; and presenting the virtual visual representation in a predetermined presenting region in the predetermined layout template.

In an implementation, the computer-executable instructions, when executed, may further cause the at least one processor 1510 to: obtain occurring place information of the target user. The predetermined layout template may comprise visual elements corresponding to the occurring place information.

In an implementation, the computer-executable instructions, when executed, may further cause the at least one processor 1510 to iteratively perform the following operations: obtaining updated real-time environment status information of the target user; determining an updated virtual visual representation corresponding to the updated real-time environment status information; forming an updated real-time virtual background through adding the updated virtual visual representation into the predetermined layout template; forming an updated mixed image corresponding to the target user through combining the updated real-time virtual background and a real-time human image of the target user; and presenting the updated mixed image in the user display region.

Moreover, the at least one processor 1510 may be further configured to perform any other step/process of the methods for providing real-time virtual background in a video session according to the above embodiments of the present disclosure.

The embodiments of the present disclosure propose a computer program product for providing real-time virtual background in a video session. The computer program product may comprise a computer program that is executed by at least one processor for: obtaining real-time environment status information of a target user, the real-time environment status information at least comprising geographic location information of the target user; determining a virtual visual representation corresponding to the real-time environment status information; forming a real-time virtual background through adding the virtual visual representation into a predetermined layout template; forming a mixed image corresponding to the target user through combining the real-time virtual background and a real-time human image of the target user; and presenting the mixed image in a user display region corresponding to the target user in a user interface of the video session. The computer program may be further executed by the at least one processor for performing any other step/process of the methods for providing real-time virtual background in a video session according to the above embodiments of the present disclosure.

The embodiments of the present disclosure may be embodied in a non-transitory computer-readable medium. The non-transitory computer readable medium may comprise instructions that, when executed, cause one or more processors to perform any step/process of the methods for providing real-time virtual background in a video session according to the above embodiments of the present disclosure.

It should be understood that all the operations in the methods described above are merely exemplary, and the present disclosure is not limited to any operations in the methods or sequence orders of these operations, and should cover all other equivalents under the same or similar concepts.

Additionally, the articles “a” and “an” as used in this description and appended claims, unless otherwise specified or clear from the context that they are for the singular form, should generally be interpreted as meaning “one” or “one or more.”

It should also be appreciated that all the modules in the apparatuses described above may be implemented in various approaches. These modules may be implemented as hardware, software, or a combination thereof. Moreover, any of these modules may be further functionally divided into sub-modules or combined together.

Processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in the present disclosure may be implemented with a micro-processor, micro-controller, digital signal processor (DSP), a field-programmable gate array (FPGA), a programmable logic device (PLD), a state machine, gated logic, discrete hardware circuits, and other suitable processing components configured to perform the various functions described throughout the present disclosure. The functionality of a processor, any portion of a processor, or any combination of processors presented in the present disclosure may be implemented with software being executed by a microprocessor, micro-controller, DSP, or other suitable platform. Software shall be construed broadly to mean instructions, instruction sets, code, code segments, program code, programs, subprograms, software modules, applications, software applications, software packages, routines, subroutines, objects, threads of execution, procedures, functions, etc. The software may reside on a computer-readable medium. A computer-readable medium may include, by way of example, memory such as a magnetic storage device (e.g., hard disk, floppy disk, magnetic strip), an optical disk, a smart card, a flash memory device, random access memory (RAM), read only memory (ROM), programmable ROM (PROM), erasable PROM (EPROM), electrically erasable PROM (EEPROM), a register, or a removable disk. Although a memory is shown as being separate from the processor in various aspects presented in this disclosure, a memory may also be internal to the processor (e.g., a cache or a register).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalents to the elements of the various aspects described throughout the present disclosure that are known or later come to be known to those of ordinary skilled in the art are intended to be encompassed by the claims.

1. A method for providing real-time virtual background in a video session, comprising:
obtaining real-time environment status information of a target user, the real-time environment status information at least comprising geographic location information of the target user;
determining a virtual visual representation corresponding to the real-time environment status information;
forming a real-time virtual background through adding the virtual visual representation into a predetermined layout template;
forming a mixed image corresponding to the target user through combining the real-time virtual background and a real-time human image of the target user; and
presenting the mixed image in a user display region corresponding to the target user in a user interface of the video session.

2. The method of claim 1, wherein the real-time environment status information further comprises:
time information corresponding to the geographic location information; and/or
weather information corresponding to the geographic location information.

3. The method of claim 1, wherein
the virtual visual representation is an image or a video frame.

4. The method of claim 1, wherein the determining a virtual visual representation comprises:
selecting a representative visual representation corresponding to the geographic location information from a geographic location-based representative visual representation library;
selecting a sky visual representation corresponding to time information and/or weather information in the real-time environment status information from a time and/or weather-based sky visual representation library; and
generating the virtual visual representation based at least on the representative visual representation and the sky visual representation.

5. The method of claim 1, wherein the determining a virtual visual representation comprises:
selecting a representative visual representation corresponding to the geographic location information from a geographic location-based representative visual representation library; and
generating the virtual visual representation based on the representative visual representation through taking time information and/or weather information in the real-time environment status information as an impact factor.

6. The method of claim 1, wherein the determining a virtual visual representation comprises:
selecting a light visual representation corresponding to time information and/or weather information in the real-time environment status information from a time and/or weather-based light visual representation library, as the virtual visual representation.

7. The method of claim 6, further comprising:
adding a second virtual visual representation corresponding to the real-time environment status information in a predetermined presenting region in the virtual visual representation.

8. The method of claim 1, wherein the predetermined layout template at least defines at least one of the following approaches for presenting the virtual visual representation:
tiling the virtual visual representation; and
presenting the virtual visual representation in a predetermined presenting region in the predetermined layout template.

9. The method of claim 1, further comprising:
obtaining occurring place information of the target user, and
wherein the predetermined layout template comprises visual elements corresponding to the occurring place information.

10. The method of claim 1, further comprising:
obtaining a real-time camera view image captured by a camera; and
extracting the real-time human image of the target user from the real-time camera view image.

11. The method of claim 1, further comprising iteratively performing the following operations:
obtaining updated real-time environment status information of the target user;
determining an updated virtual visual representation corresponding to the updated real-time environment status information;
forming an updated real-time virtual background through adding the updated virtual visual representation into the predetermined layout template;
forming an updated mixed image corresponding to the target user through combining the updated real-time virtual background and a real-time human image of the target user; and
presenting the updated mixed image in the user display region.

12. An apparatus for providing real-time virtual background in a video session, comprising:
at least one processor; and
a memory storing computer-executable instructions that, when executed, cause the at least one processor to:
obtain real-time environment status information of a target user, the real-time environment status information at least comprising geographic location information of the target user,
determine a virtual visual representation corresponding to the real-time environment status information,
form a real-time virtual background through adding the virtual visual representation into a predetermined layout template,
form a mixed image corresponding to the target user through combining the real-time virtual background and a real-time human image of the target user, and
present the mixed image in a user display region corresponding to the target user in a user interface of the video session.

13. The apparatus of claim 12, wherein the determining a virtual visual representation comprises:
selecting a representative visual representation corresponding to the geographic location information from a geographic location-based representative visual representation library;
selecting a sky visual representation corresponding to time information and/or weather information in the real-time environment status information from a time and/or weather-based sky visual representation library; and
generating the virtual visual representation based at least on the representative visual representation and the sky visual representation.

14. The apparatus of claim 12, wherein the determining a virtual visual representation comprises:
selecting a representative visual representation corresponding to the geographic location information from a geographic location-based representative visual representation library; and
generating the virtual visual representation based on the representative visual representation through taking time information and/or weather information in the real-time environment status information as an impact factor.

15. A computer program product for providing real-time virtual background in a video session, comprising a computer program that is executed by at least one processor for:
obtaining real-time environment status information of a target user, the real-time environment status information at least comprising geographic location information of the target user;
determining a virtual visual representation corresponding to the real-time environment status information;
forming a real-time virtual background through adding the virtual visual representation into a predetermined layout template;
forming a mixed image corresponding to the target user through combining the real-time virtual background and a real-time human image of the target user, and
presenting the mixed image in a user display region corresponding to the target user in a user interface of the video session.
